(19) United States
(12) Patent Application Publication
(10) Pub. No.: US 2015/0172222 A1
(43) Pub. Date: Jun. 18, 2015

(54) DATA CENTER ETHERNET SWITCH FABRIC

(71) Applicants: James Liao, Palo Alto, CA (US); Hei Tao Fung, Fremont, CA (US); David Liu, Livermore, CA (US)

(72) Inventors: James Liao, Palo Alto, CA (US); Hei Tao Fung, Fremont, CA (US); David Liu, Livermore, CA (US)

(21) Appl. No.: 14/107,186

(22) Filed: Dec. 16, 2013

(51) Int. Cl. H04L 12/931; H04L 12/823; H04L 29/12

(52) U.S. Cl. CPC H04L 49/351; H04L 49/70; H04L 61/6022; H04L 61/6004; H04L 47/32

(57) ABSTRACT

A system, method, and computer program product are provided for providing a multi-tenant data center Ethernet switch fabric that enables communications among virtual machines. A controller assigns location-based MAC addresses to the virtual machines and programs the Ethernet switch fabric to forward packets by the location information embedded in the location-based MAC addresses.

### FIELD OF THE INVENTION

This application relates to computer networking and more particularly to providing a data center Ethernet switch fabric.

### BACKGROUND

A data center is a facility used to house computer systems and associated storage and networking components. For interconnecting the computer systems and storage components, an Ethernet switch fabric is often used. Connecting Ethernet switches in a fat-tree topology and managing them as Local Area Networks (LANs) with spanning tree protocol (STP) or as Internet Protocol (IP) subnets with routing protocols have been a typical practice. However, there are some short-comings associated with the practice. For example, the switching paths among end-stations are static; therefore, the network is susceptible to network congestion without alleviation and is unable to address the mobility of virtual machines (VMs) where VMs may be dynamically spawned or moved. Also, a hosting data center may need to support tens of thousands tenants and need to set up traffic forwarding boundaries among the tenants. If a Virtual LAN (VLAN) is used to confine the traffic of a tenant, a layer 2 switching network is limited to supporting 4094 tenants.

There is recent development in network virtualization technology that attempts to scale the capacity of tenancy beyond the 4094 limit. One example is Virtual Extensible LAN (VxLAN). It encapsulates Ethernet frames within UDP (User Datagram Protocol) packets. However, one weakness in that approach is not being able to manage the congestion in the underlying switch fabric.

Software defined networking (SDN) is an approach to building a computer network that separates and abstracts elements of the networking systems. SDN decouples the system that makes decisions about where traffic is sent (i.e., the control plane or the controller) from the system that forwards traffic to the selected destination (i.e., the data plane). OpenFlow is a communications protocol that enables the control plane to access and configure the data plane. Recently, there have been commodity OpenFlow Ethernet switches in the market. Those switches are relatively low-cost, but they also have severe limitations in terms of the number of forwarding rules. Supposedly, an OpenFlow device offers the ability of controlling the traffic by flows in a data center switch fabric. The ability can be utilized in alleviating congestion or addressing VM mobility issues. The severe limitations of those switches greatly discount the ability because the number of forwarding rules that can be programmed on those switches is relatively small, e.g. in thousands.

In this invention, we disclose a system, method and computer program product of using commodity switches to provide an Ethernet switch fabric for multi-tenant data center, taking into account the limitations of the commodity switches.

### SUMMARY OF THE INVENTION

We disclose herein a system, method, and computer program product for providing an Ethernet switch fabric for multi-tenant data center. An objective of the invention is to enable a hosting data center to support no less than tens of thousands of tenants. Another objective is to support dynamic traffic engineering within the switch fabric so as to address network congestion conditions and dynamic VM deployment. Yet another objective is to provide a switch fabric constructed with commodity switches which may support only a small number of forwarding rules for traffic engineering.

The system comprises a number of interconnected Ethernet switches, a number of virtual switches running on host machines, and a controller. Some of the Ethernet switches are considered to be edge switches when they own an edge port. An edge port is a switch port that is connected to a host machine. On a host machine, it runs a virtual switch and one or more VMs. The virtual switch provides connectivity among the VMs on the host machine and one or more edge ports. The controller is a computer program that implements the method of this invention. The controller assigns MAC addresses to the VMs and programs the Ethernet switches and the virtual switches.

The method comprises two key steps. One step assigns a unique, location-based MAC address to each VM that is spawned on a host machine. The MAC address assigned to a VM comprises a set of bits that identifies the location of the VM with respect to the switch fabric. Another step programs the Ethernet switches and the virtual switches in the switch fabric to forward a unicast packet destined to the MAC address by at least one bit of the set of bits of the MAC address. Furthermore, the virtual switch is programmed to discard all packets from the VM whose source MAC addresses are not the MAC address of the VM. The virtual switch is programmed to discard unicast packets from the VM that are not destined to other members of the tenant group of the VM. A broadcast packet from the VM is handled by converting the broadcast packet into one or more unicast packets by replacing the destination MAC address of the broadcast packet by the MAC addresses of the other members of the tenant group of the VM.

By assigning structured, location-based MAC addresses for VMs, the switch fabric enables traffic engineering with a relatively small number of forwarding rules programmed on the Ethernet switches. Also, the VMs of various tenant groups are not separated by VLANs in the present invention. The traffic of the VMs of various tenant groups is constrained by forwarding rules. Because the forwarding rules do not rely on VLAN identifiers, there can be more than 4094 tenant groups.

### BRIEF DESCRIPTION OF THE DRAWINGS/FIGURES

The present disclosure will be understood more fully from the detailed description that follows and from the accompanying drawings, which however, should not be taken to limit the disclosed subject matter to the specific embodiments shown, but are for explanation and understanding only.

FIG. 1 illustrates an exemplary deployment scenario of the present invention.

FIG. 2a-2d illustrate some exemplary implementations of MAC address assigned to a VM.

FIG. 3a-3h illustrate some exemplary implementations of forwarding rules on the switch fabric.

FIG. 4a-4d illustrate some exemplary implementations of using location-based MAC address.

FIG. 5 illustrates an implementation of the processing flow of a controller of the present invention.

FIG. 6 illustrates some exemplary functional modules of a controller of the present invention.

### DETAILED DESCRIPTION OF THE INVENTION

We disclose herein a system, method, and computer program product for providing an Ethernet switch fabric for multi-tenant data center. The system comprises a number of interconnected Ethernet switches, a number of virtual switches running on host machines, and a controller. The controller is a computer program that implements the method of this invention. The controller assigns location-based MAC addresses to the VMs and programs the Ethernet switches and the virtual switches to forward traffic by the location-based MAC addresses.

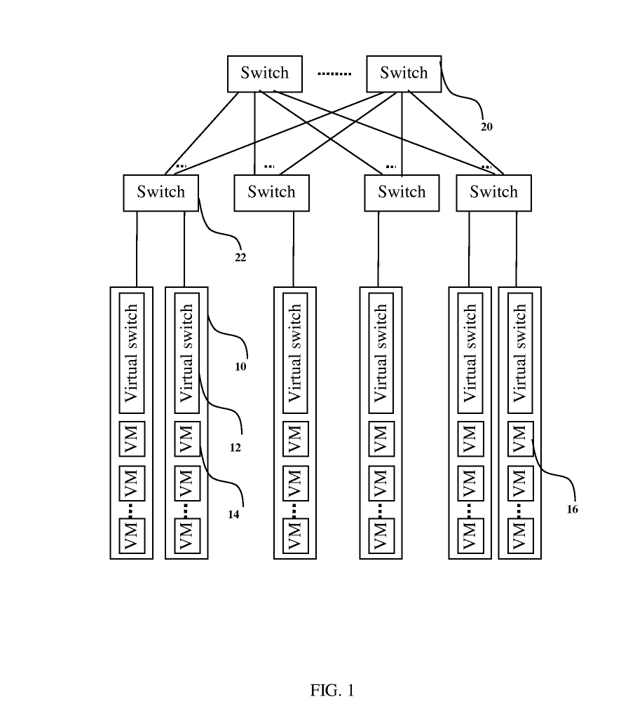

FIG. 1 shows an exemplary deployment scenario of the present invention. It is a data center network with a tier of spine switches and a tier of edge switches connecting a tier of host machines together. Switch 20 is a spine switch. The main purpose of spine switches is to provide connectivity among edge switches. Switch 22 is an edge switch. An edge switch has at least one edge port. An edge port is a switch port connecting to a host machine. Switch 22 is connected to host machine 10. A host machine typically comprises a virtual switch and at least one virtual machine. Host computer 10 comprises virtual switch 12, virtual machine 14 and other VMs. A virtual switch is a software component running on a host machine. A virtual switch provides logical connectivity among the virtual machines running on the host machine and at least one edge switch through the virtual network interfaces of the virtual switch. A virtual network interface (VNI) may be mapped to a physical network interface card (NIC) to an edge port of an edge switch. A virtual network interface may also be mapped to a virtual NIC of a VM. A data center may provide services for multiple tenants. Each VM may belong to one tenant group. VMs of the same tenant group constitute a virtual private network. For example, if VM 14 and VM 16 belong to the same tenant group while other VMs do not, then a broadcast packet from VM 14 is limited to VM 16. The tenant groups are isolated from each other. There may be a gateway in the network that enables communications among the tenant groups, if so desired. The gateway may also provide network access outside the data center network, if so desired. The gateway is to be a member of the tenant groups that desire the services. The gateway can be implemented as one special VM or one special host machine.

In a typical data center network, a VM is uniquely identified by an identifier, such as UUID (Universally Unique Identifier), generated by a data center orchestration tool. The data center orchestration tool also manages the tenant group membership of the VM and the attributes of the VM. A tenant who uses the VMs of his tenant group may have control over the IP address assignments or even the VLAN assignments of the VMs in his virtual private network. The tenant may or may not have control over the MAC address assignments of his VMs. To the tenant, an IP address identifies a VM. The tenant is not given the knowledge about the location of the VM. The data center orchestration tool has knowledge about the location of the VM.

In the present invention, the controller assigns a MAC address to a VM in a way that the MAC address embeds the location of the VM so that the controller can program the switch fabric to forward traffic to the VM by MAC addresses. In other words, the forwarding decisions are independent of IP addresses or any other networking parameter that the tenant has control. In other words, the IP datagram encapsulated inside an Ethernet frame is opaque to the switch fabric. The switch fabric no longer functions as a standard Ethernet network such as running spanning tree protocol, having MAC address learning, and forwarding by destination MAC address and VLAN identifier even though the switch fabric comprises Ethernet switches. The switch fabric in the present invention forwards a packet using the destination MAC address, not using the full destination MAC address, but using only the bits of the destination MAC address that provide location information, thereby reducing the number of forwarding rules to be programmed on the switch fabric.

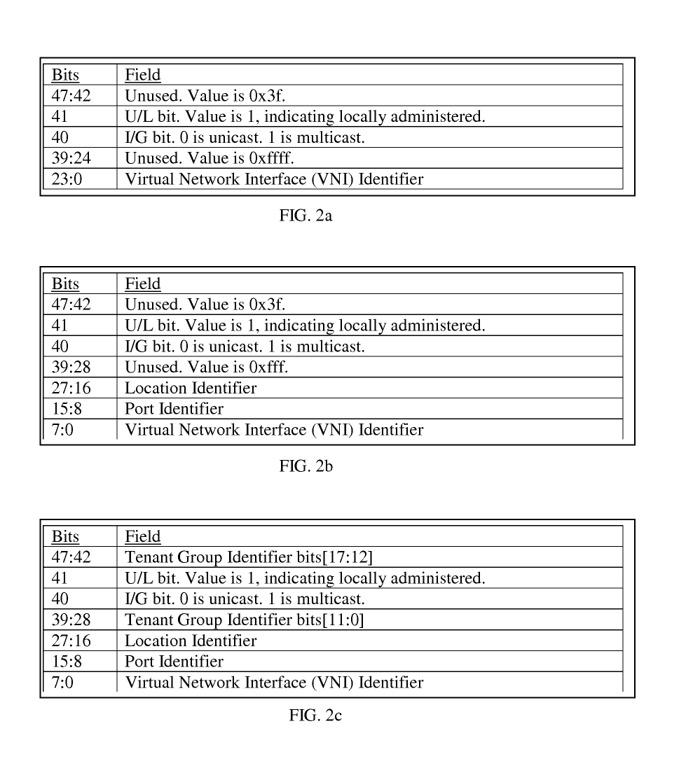

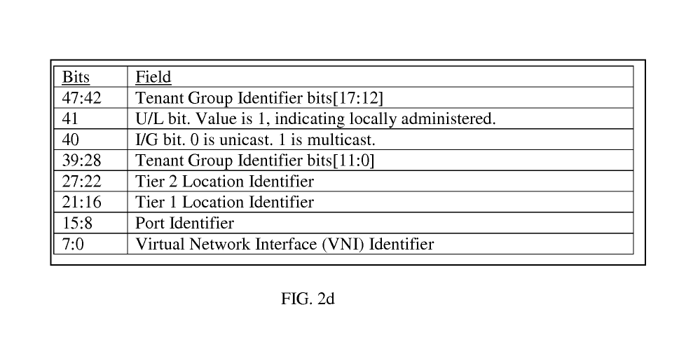

There can be various embodiments how the location of the VM is embedded into a MAC address. In one embodiment, as in FIG. 2a, the MAC address comprises a virtual network interface (VNI) identifier. The VNI identifier indicates a unique VM location with respect to the data center fabric. A 24-bit VNI identifier field can indicate sixteen millions of locations of VMs. The 41th bit of the MAC address is set to 1 to indicate that the MAC address is not globally unique but locally administered by the controller.

In another embodiment, as in FIG. 2b, the MAC address comprises a location identifier, a port identifier, and a VNI identifier. The three fields together indicate a unique VM location with respect to the data center fabric. The location identifier indicates a unique edge switch location with respect to the data center fabric. The port identifier indicates a unique edge port location with respect to the edge switch indicated by the location identifier. The VNI identifier indicates a unique virtual network interface location with respect to the virtual switch logically connected to the edge port indicated by the port identifier.

Yet in another embodiment, as in FIG. 2c, the MAC address further comprises a tenant group identifier, compared to the embodiment in FIG. 2b. The 18-bit tenant group identifier is split into two parts, the 42^{nd}-47^{th} bits and the 28^{th}-39^{th} bits of the MAC address. The tenant group identifier indicates the tenant group to which the VM belongs. The tenant group identifier is not location related, but its presence helps minimizing the number of forwarding rules to be programmed in the switch fabric.

Yet in another embodiment, as in FIG. 2d, the MAC address comprises a tier 2 location identifier and a tier 1 location identifier, as opposed to one combined location identifier in the embodiment in FIG. 2c. The presence of tier 2 and tier 1 location identifiers can help minimizing the number of forwarding rules to be programmed on the spine switches in the switch fabric. Also, it can help partitioning the MAC address space to be allocated by split controllers, where the controller is split into multiple split controllers and each split controller manages a partition of the switch fabric while the partitions of the switch fabric are geographically separated by an IP network.

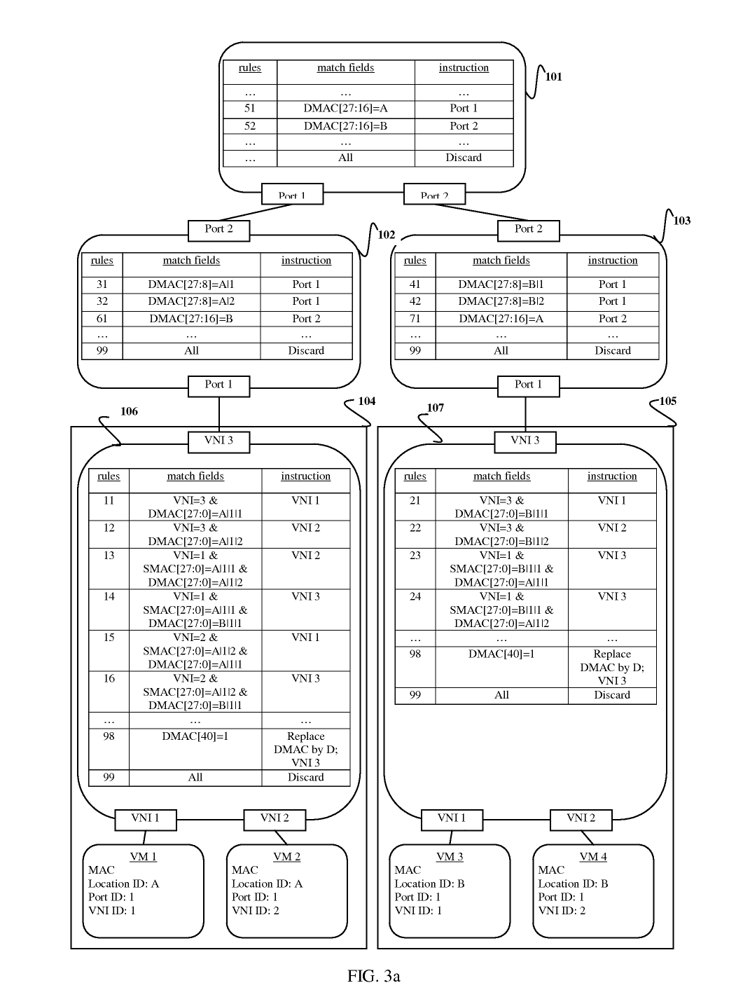

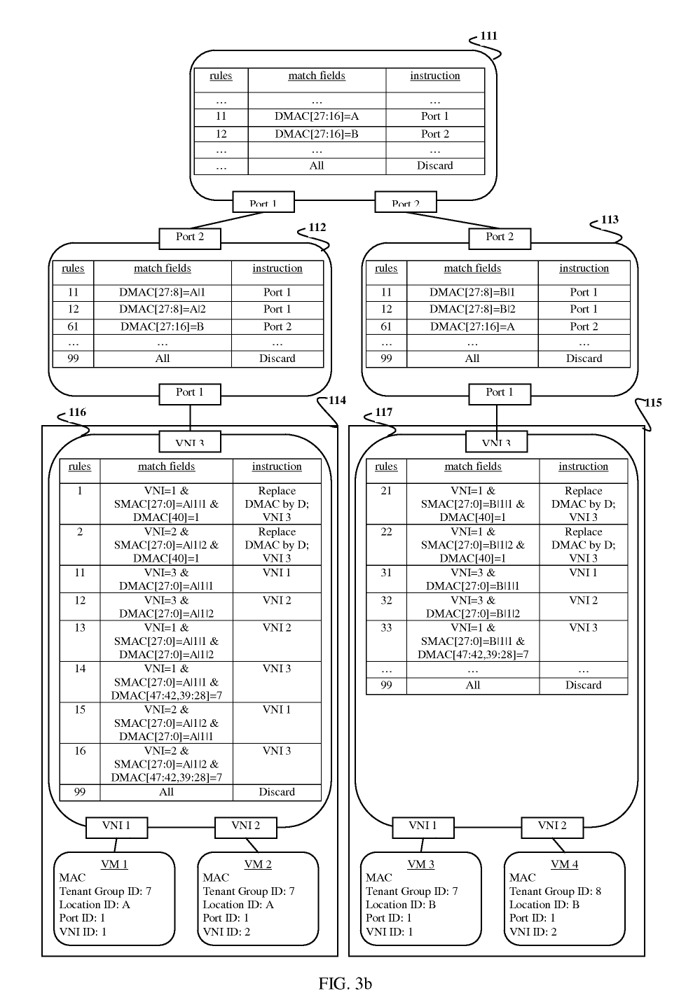

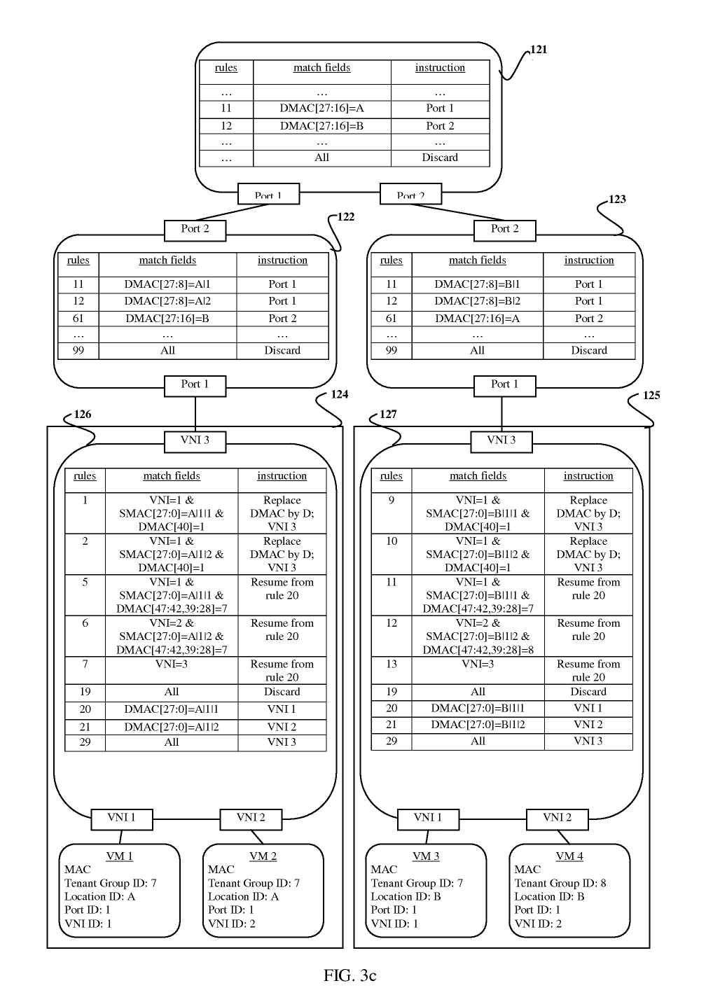

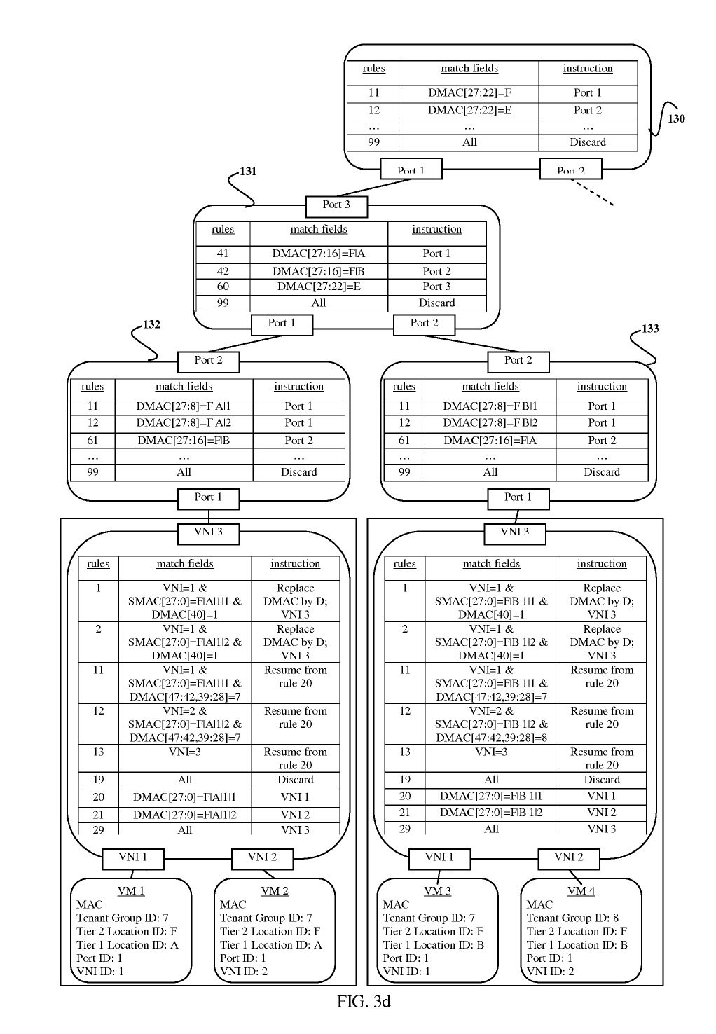

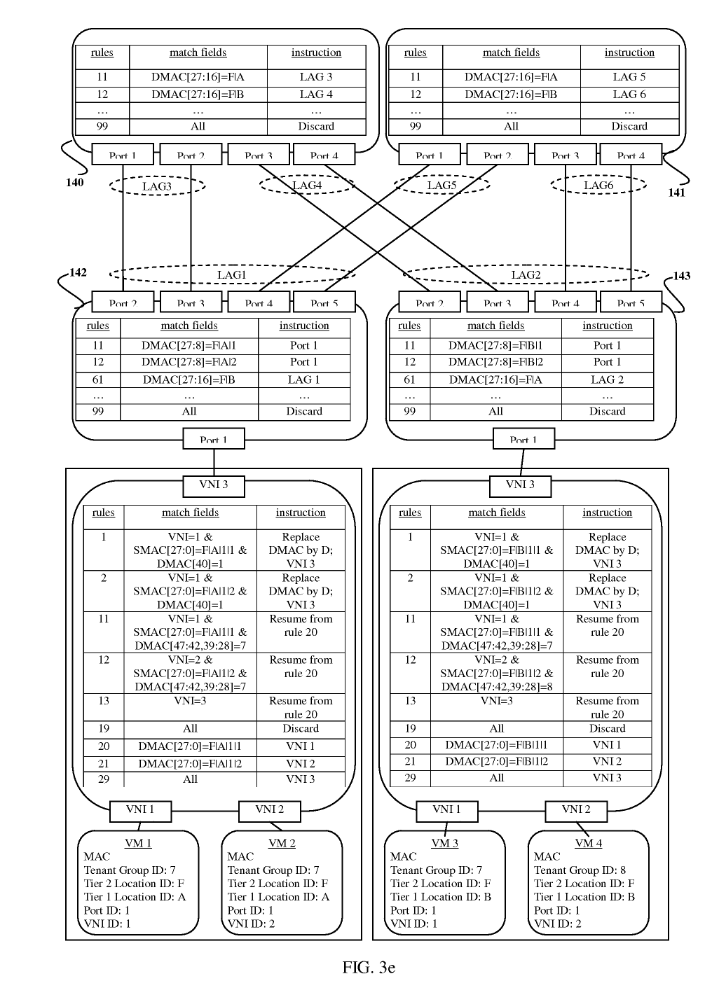

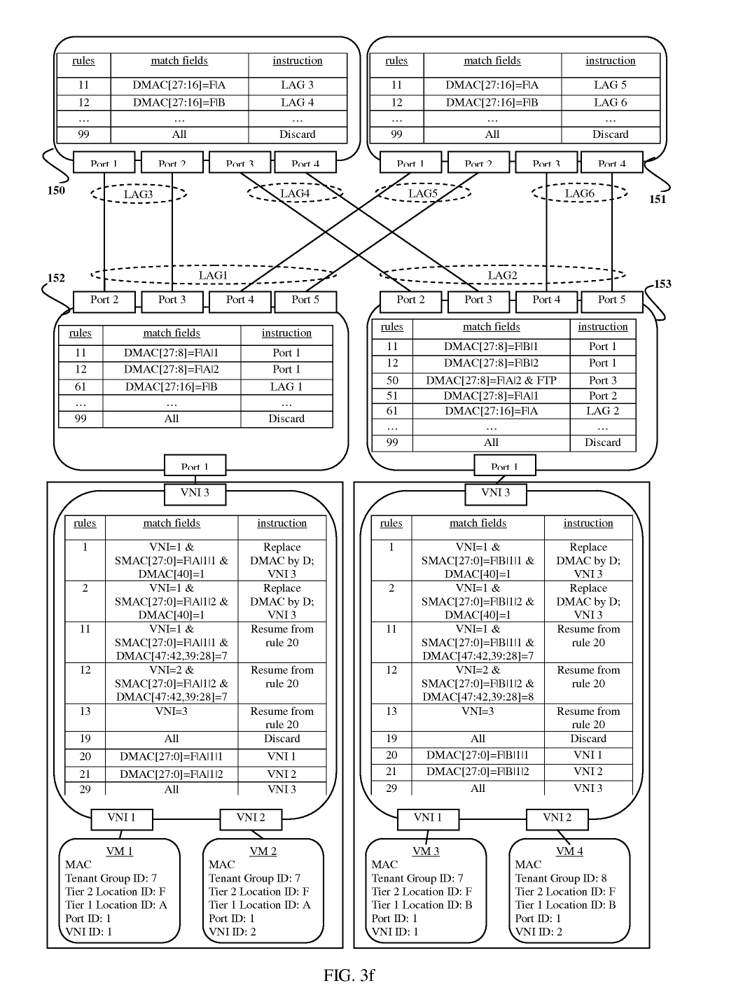

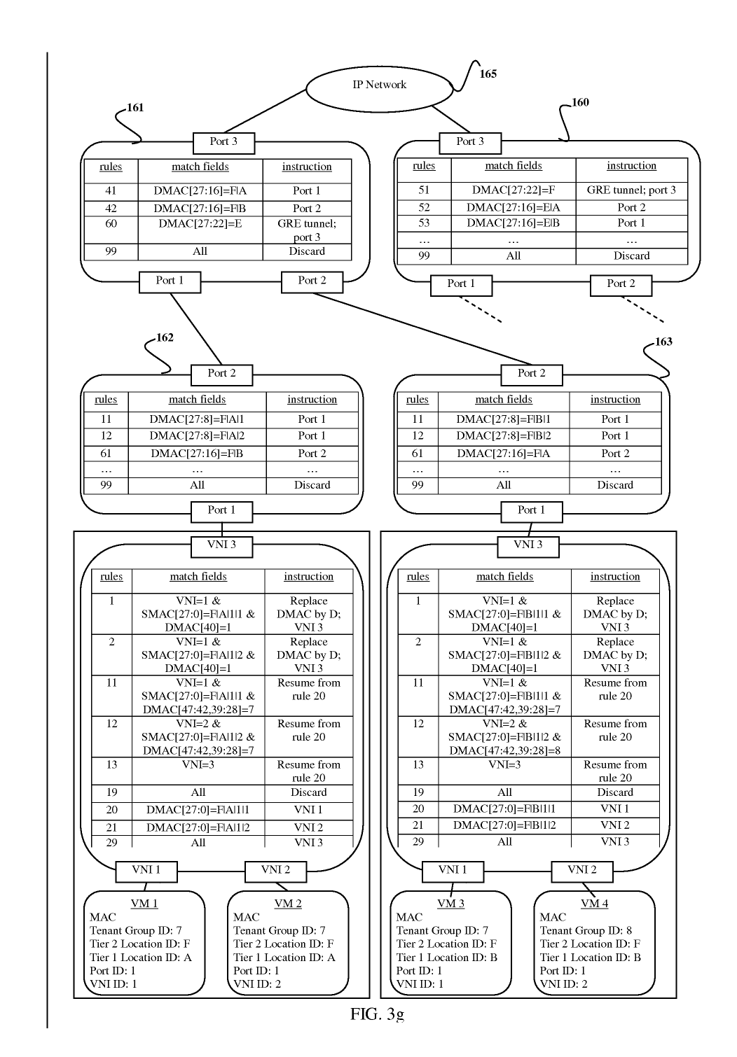

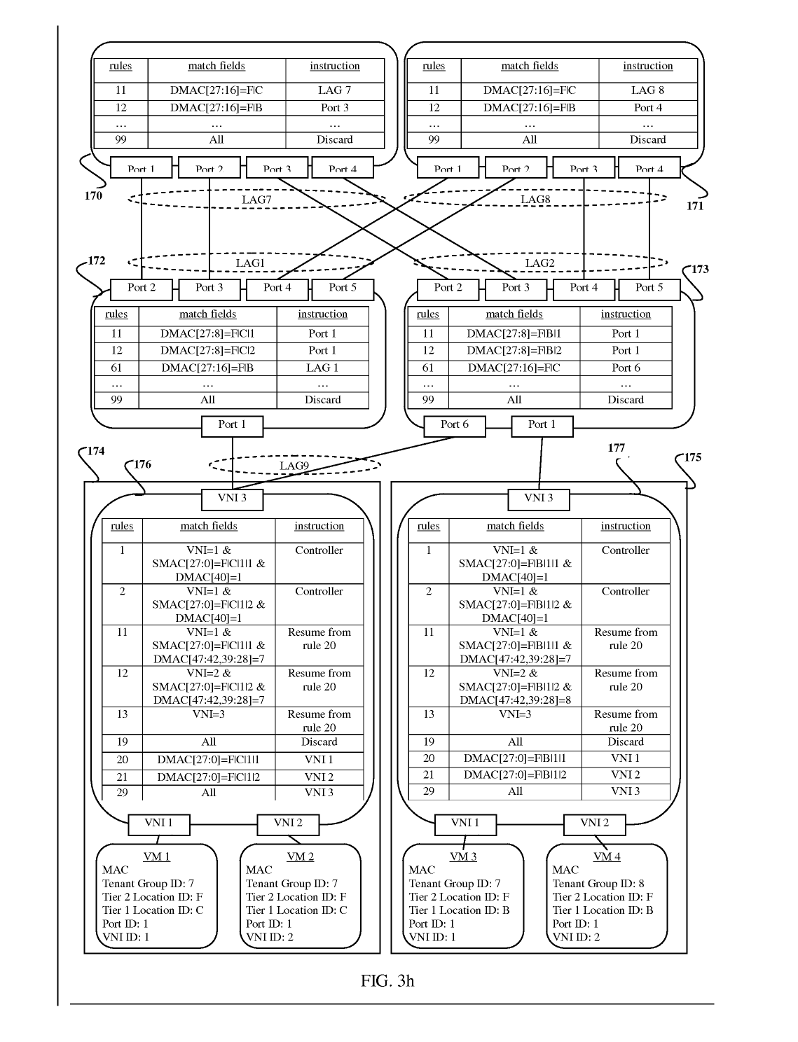

There can be various embodiments of forwarding rules in the switch fabric to forward multi-tenant data center traffic by location-based MAC addresses. FIG. 3a illustrates one embodiment of forwarding rules. In FIG. 3a, there is a spine switch 101, connecting through port 1 to port 2 of edge switch 102 and through port 2 to port 2 of edge switch 103. Port 1 of edge switch 102 is logically connected to VNI 3 of virtual switch 106 of host machine 104. Similarly, Port 1 of edge switch 103 is logically connected to VNI 3 of virtual switch 107 and host machine 105. VNI 1 and VNI 2 of virtual switch 106 are logically connected to VM 1 and VM 2, respectively. Similarly, VNI 1 and VNI 2 of virtual switch 107 are logically connected to VM 3 and VM 4, respectively. VM 1, VM 2, and VM 3 belong to the same tenant group. VM 4 does not. The forwarding rules embodiment of FIG. 3a is compatible with MAC address embodiments of FIG. 2b and FIG. 2c.

The forwarding rules are ordered by their priorities. The smaller the rule number, the highest the priority of execution. In FIG. 3a, rule 99 is a default forwarding rule to drop all packets that do not match any higher priority rule. Rules 13 and 15 enable VM 1 and VM 2 to send to each other. Rules 14 and 16 enable VM 1 and VM 2 to send to VM 3. Rules 11 and 12 enable all other tenant group members outside virtual switch 106 to send to VM 1 and VM 2.

The forwarding rules on virtual switches are constructed to match the ingress VNI, the source MAC address (SMAC), and the destination MAC address (DMAC) of the packets from VMs for the following reasons. Firstly, a virtual switch is to discard a packet from a VM to another VM not of the same tenant group. Secondly, a virtual switch is to discard a packet from a VM whose source MAC address do not match the MAC address assigned to the VM. That prevents a tenant from forging MAC address to spoof other tenants.

Broadcast packets from VMs are handled specially. A broadcast packet should be forwarded to all tenant group members other than the sender. An entity aware of the tenant group membership may convert the broadcast packet into unicast packets by replacing the destination MAC address (DMAC) with the MAC addresses assigned to the other tenant group members. In one embodiment, the controller does the broadcast packet conversion, having the virtual switch to capture the broadcast packet via an OpenFlow session and injecting the corresponding unicast packets into the switch fabric via OpenFlow sessions. In another embodiment, a special gateway does the broadcast packet conversion, having the virtual switch to forward the broadcast packet to the special gateway by replacing the destination MAC address of the broadcast packet with a special MAC address of the special gateway. The special gateway is attached to the switch fabric, and there are forwarding rules on the Ethernet switches for the special MAC address. For example, rule 98 forwards a broadcast packet to a special gateway whose MAC address is D. In yet another embodiment, the virtual switch does the broadcast packet conversion. The controller informs the virtual switch of the tenant group membership information.

An ARP (Address Resolution Protocol) request from a VM needs a response so that the IP stack of the VM can send unicast packets to a target tenant group member. An entity aware of the tenant group membership needs to generate the response. In one embodiment, the controller generates the ARP response, having the virtual switch capture an ARP request via an OpenFlow session and injecting the ARP response via the same OpenFlow session. In another embodiment, a special gateway generates the ARP response, having the virtual switch to forward the broadcast ARP request packet to the special gateway by replacing the destination MAC address of the broadcast ARP request packet with a special MAC address of the special gateway. For example, rule 98 forwards a broadcast packet to a special gateway whose MAC address is D. In yet another embodiment, an ARP request is treated as a typical broadcast packet and it is converted into multiple unicast ARP request packets to all other tenant group members. A tenant group member of the MAC address in the ARP request is to respond to the sender of the ARP request directly. In yet another embodiment, the virtual switch generates the ARP response to the VM. The controller informs the virtual switch of the tenant group membership information.

On an edge switch, the forwarding rules do not need to match the VNI identifier of the destination MAC address of a packet. A packet whose location identifier of the destination MAC address matches the location identifier assigned to the edge switch should be forwarded to an edge port further according to the port identifier of the destination MAC address. A packet whose location identifier of the destination MAC address does not match the location identifier assigned to the edge switch should be forwarded to a non-edge port that can lead to the edge switch associated with the location identifier of the destination MAC address. For example, edge switch 102 is assigned location identifier A, and edge switch 103 is assigned location identifier B. On edge switch 102, a packet whose location identifier of the destination MAC address matches B is forwarded to port 2 which can lead to edge switch 103 through spine switch 101.

There is no location identifier assigned to a spine switch in the case of MAC address embodiments of FIG. 2b and FIG. 2c. The forwarding rules are programmed to forward a packet to a port according to the location identifier of the destination MAC address of the packet. For example, spine switch 101 forwards a packet whose location identifier of the destination MAC address matches B to port 2.

FIG. 3b illustrates another embodiment of forwarding rules compatible with MAC address embodiment of FIG. 2c. It illustrates that using the tenant group identifier can help reduce the number of forwarding rules on a virtual switch. When a VM has multiple remote tenant group members, a forwarding rule that matches the tenant group identifier of the destination MAC address of a packet is sufficient. For example, FIG. 3b has the same network topology as FIG. 3a. VM 3 has two remote tenant group members, namely VM 1 and VM 2. Rule 33 of virtual switch 117 forwards a unicast packet from VM 3 to VNI 3 when the tenant group identifier of the destination MAC address is the same as the tenant group identifier assigned to VM 3.

FIG. 3c illustrates yet another embodiment of forwarding rules compatible with MAC address embodiment of FIG. 2c. FIG. 3c has the same network topology as FIG. 3b. The forwarding rules on a virtual switch are optimized in the embodiment of FIG. 3c. There are a set of highest priority forwarding rules that enable the VMs connected to the virtual switch to send broadcast packets and unicast packets to the tenant group members of the VMs and that permit packets from the edge ports. If none of those highest priority forwarding rules has a match, the packet is discarded. If one of those highest priority forwarding rules has a match, decision processing may resume from some lower priority forwarding rules that match on the VNI identifier of the destination MAC address. The advantage of such embodiment is that the number of forwarding rules on the virtual switch can be in the order of N, where N is the number of VMs connected to the virtual switch.

For example, in FIG. 3c on virtual switch 126, rules 1 and 2 forward the broadcast packets from VM 1 and VM 2. Rules 5 and 6 perform a security check on the unicast packets from VM 1 and VM 2. Packets from edge port should have passed security check, so rule 7 permits all packets from VNI 3. Rule 19 discards all packets that fail security check. Rules 20 and 21 forward the packets to VM 1 and VM 2. Rule 29 forwards all other packets to the edge port.

FIG. 3d illustrates a forwarding rules embodiment compatible with the MAC address embodiment of FIG. 2d. FIG. 3d has similar network topology to FIG. 3c, but a tier 1 spine switch 131 is connected to a tier 2 spine switch 130. Tier 2 spine switch 130 is supposed to connect to other spine switches not shown in the figure. Edge switch 132 is assigned a tier 1 location identifier A. Edge switch 133 is assigned a tier 1 location identifier B. Spine switch 131 is assigned a tier 2 location identifier F. Spine switch 130 is able to reach another spine switch assigned with tier 2 location identifier E. Spine switch 131 has rules 41 and 42 to forward a packet whose tier 2 location identifier of the destination MAC address matches its assigned tier 2 location identifier to a downstream port leading to an edge switch. Spine switch 131 also has rule 60 to forward a packet whose tier 2 location identifier of the destination MAC address does not match its assigned tier 2 location identifier to a port that leads to another spine switch.

FIG. 3e illustrates a forwarding rules embodiment for a network topology with redundant links. It is advantageous to use link aggregation (LAG) to bundle the physical ports. In other words, an edge port can be a logical edge port, mapped to a LAG. Then we can take advantage some quick link failure detection and link failover capability on typical Ethernet switches. The upstream ports of an edge switch can be bundled as one LAG. The downstream ports of a spine switch can be bundled as one or more LAGs, each LAG leading to one edge switch. For example, ports 2-5 on edge switch 142 are bundled as LAG 1. Ports 1-2 on spine switch 140 are bundled as LAG 3, and ports 3-4 on spine switch 140 are bundled as LAG 4. LAG 3 leads to edge switch 142 and LAG 4 leads to edge switch 143. The forwarding rules can specify a LAG as the output port. It is up to the LAG traffic distribution algorithm on an Ethernet switch to select one physical port out of the LAG to send out a packet. It is typical that the LAG traffic distribution algorithm uses a hash value on the packet header fields of a packet to select the physical port.

FIG. 3f illustrates a forwarding rules embodiment for dynamic load-balancing or congestion alleviation. For example, when the controller detects congestion on LAG 2, the controller can program new forwarding rules to divert some packet flows to specific ports. On edge switch 153, rule 50 is one such forwarding rule. It directs File Transfer Protocol (FTP) packets to port 3. Rule 51 is another one. It directs traffic to a specific VM out on port 2, overriding the LAG load distribution algorithm for LAG 2.

The controller can update the forwarding rules on the switch fabric dynamically. Some forwarding rules previously programmed may need to be relocated to make room for new forwarding rules so as to maintain proper rule execution priorities.

FIG. 3g illustrates a forwarding rules embodiment for a switch fabric spread over two geographical partitions separated by an IP network 165. The network topology and configurations are similar to FIG. 3d, only that port 3 of spine switch 161 is connected to an IP network. The spine switch 160 of another partition of the switch fabric is also connected to the IP network 165. The spine switch 160 is assigned a tier 2 location identifier E. Spine switch 160 forwards all packets whose destination MAC addresses comprise the tier 2 location identifier F to spine switch 161 by tunneling the packets through the IP network 165. Similarly, the spine switch 161 forwards all packets whose destination MAC addresses comprise the tier 2 location identifier E to spine switch 160 by tunneling the packets through the IP network 165. An implementation of tunneling is Generic Routing Encapsulation (GRE). Another implementation of tunneling is Multiprotocol Label Switching (MPLS). It is possible that the two switch fabric partitions are managed by two different instances of data center orchestration tool and two different instances of controller. The partition controller for the switch fabric partition comprising spine switch 161 is responsible for location-based MAC address assignments involving tier 2 location identifier F, and the partition controller for the switch fabric partition comprising spine switch 160 is responsible for location-based MAC address assignments involving tier 2 location identifier E. In other words, the controller is logically split into two partition controllers. The partition controllers are running on different processors.

FIG. 3h illustrates a forwarding rules embodiment for a network topology with redundant links from a host machine to two edge switches. The host machine 174 has two NICs and VNI 3 of virtual switch 176 is mapped to the two NICs. The two NICs are bonded as LAG 9. NIC bonding offers benefits of quick link failure detection and link failover capability. As LAG 9 spans to edge switch 172 and edge switch 173, edge switches 172 and 173 are to share tier 1 location identifier C. In other words, edge switches 172 and 173 form a switch aggregation from the viewpoint of the location of VM 1 and VM 2. In this case, the tier 1 location identifier indicates the location of a logical Ethernet switch with respect to the data center fabric. The logical Ethernet switch is mapped to the switch aggregation. However, edge switch 173 is the only edge switch to host machine 175, so edge switch 173 is also associated with tier 1 location identifier B. Spine switches 170 and 171 are programmed accordingly to accommodate the tier 1 location identifier C of the logical Ethernet switch and the tier 1 location identifier B of edge switch 173. Ports 1-4 of spine switch 170 can form one LAG, and ports 1-4 of spine switch 171 can form one LAG.

The controller may update the forwarding rules on the switch fabric in response to network topology changes such as link status change and insertion or failure of Ethernet switches. In response to failure of an Ethernet switch, there can be various embodiments. In one embodiment, using an aggregation of Ethernet switches as in FIG. 3h can deal with a failure without the need for re-programming the forwarding rules on the active Ethernet switches. In another embodiment, the controller may have at least one active Ethernet switch to take up the location identifier of the failed Ethernet switch. In yet another embodiment, the controller may change the location-based MAC addresses of the impacted VMs.

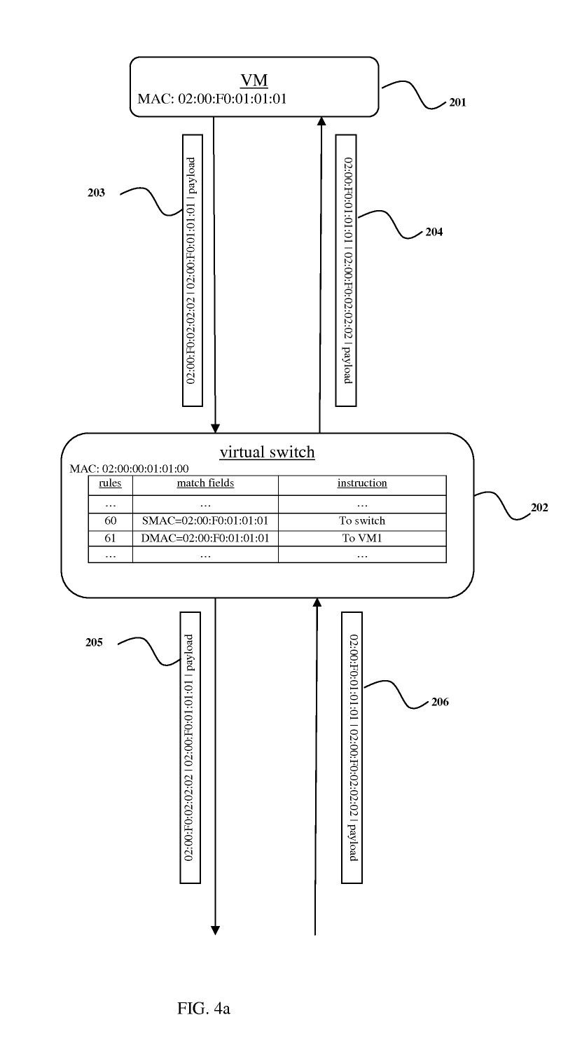

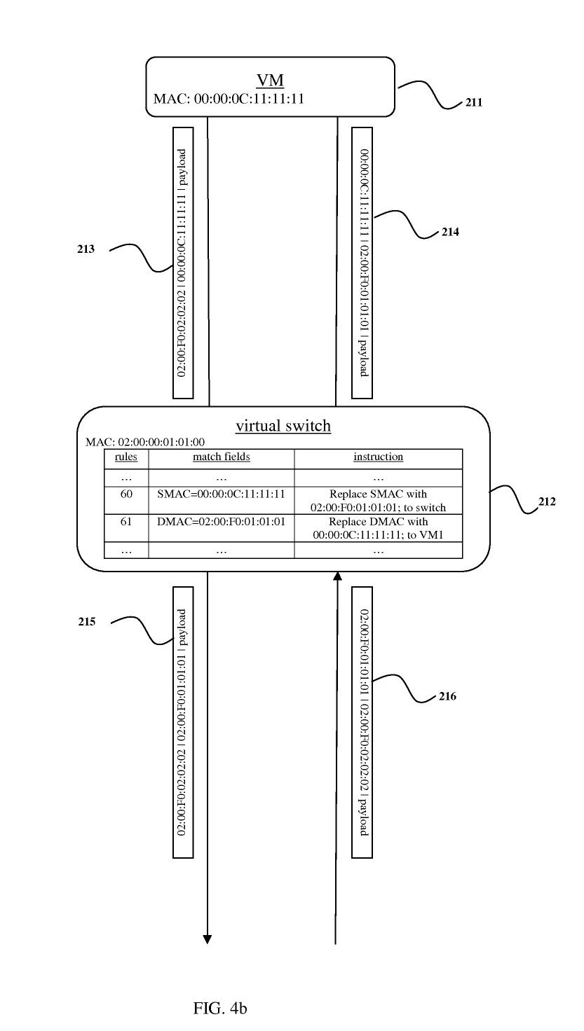

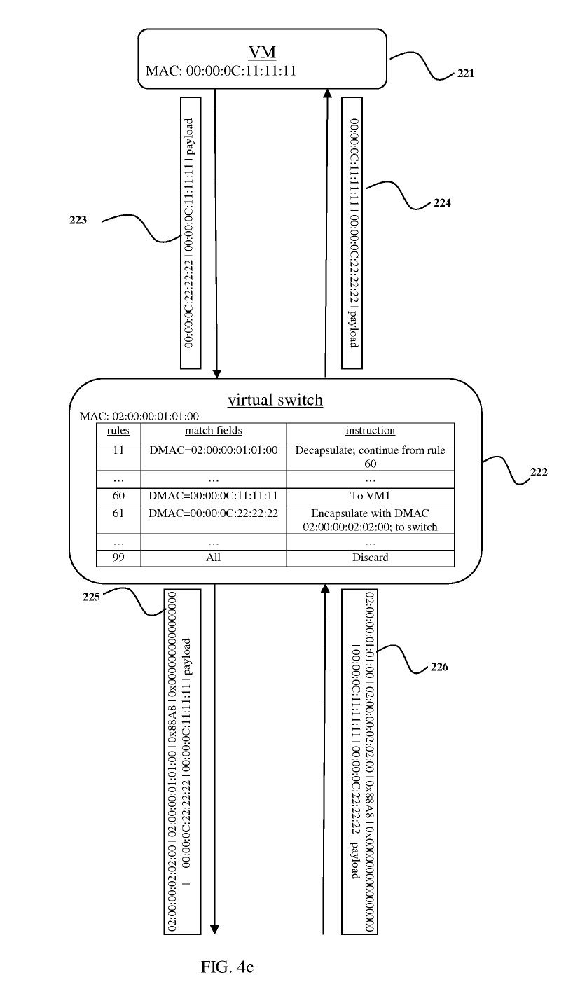

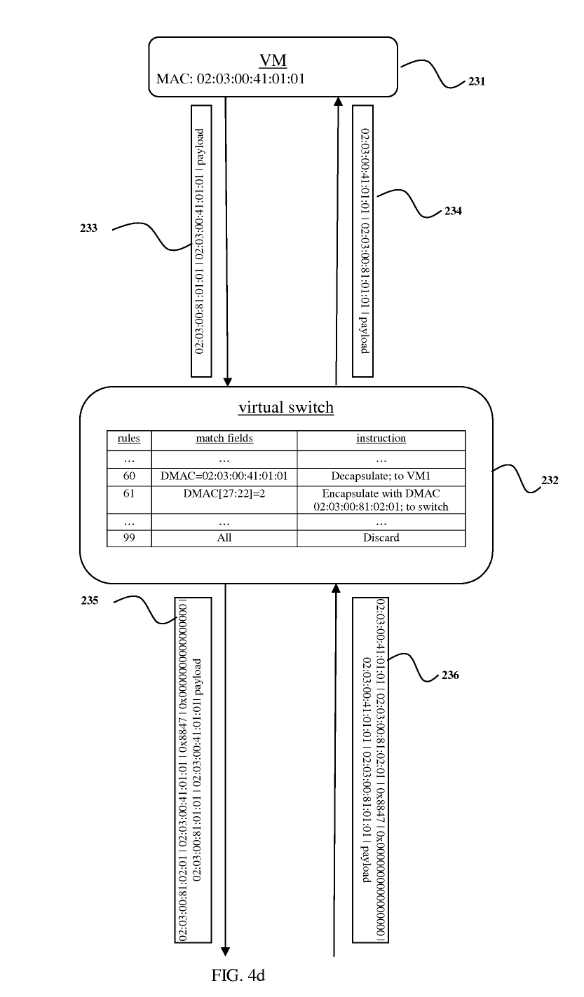

There can be various embodiments how location-based MAC addresses can be associated with VMs. FIG. 4a illustrates one embodiment. A VM uses the assigned location-based MAC address on its network interface so that the source MAC address of all packets sent from the VM is the location-based MAC address. Since an ARP response to the VM's ARP request provides a location-based MAC address for its target, the destination MAC address of unicast packets from the VM is also a location-based MAC address. Similarly, the destination MAC address of a packet destined to the VM is the location-based MAC address of the VM. For example, VM 201 uses location-based MAC address 02:00:F0:01:01:01 directly. Packet 203 uses the MAC address as the source MAC address. Virtual switch 202 forwards packet 203 as it, so packet 205 is exactly the same as packet 203. In the downstream direction from virtual switch 202 to VM 201, packet 206 is the same as packet 204.

FIG. 4b illustrates another embodiment of using location-based MAC address. VM 211 uses a globally unique MAC address or a MAC address of the tenant's choice on its network interface. The source MAC address of all packets from VM 211 is 00:00:0C:11:11:11. Virtual switch 212 maintains a mapping between the MAC address of VM 211 and the location-based MAC address assigned to VM 211. VM 211 is not aware of the location-based MAC address 02:00:F0:01:01:01. Virtual switch 212 replaces the source MAC address of a packet from VM 211 with VM 211's assigned location-based MAC address. For example, packet 213 is converted to packet 215. Virtual switch 212 also replaces the destination MAC address of a packet destined to VM 211 with VM 211's actual MAC address. For example, packet 216 is converted to packet 214.

FIG. 4c illustrates yet another embodiment of using location-based MAC address. VM 221 uses a globally-unique MAC address and is not aware of any location-based MAC address. Even the ARP response to VM 221's ARP request provides a globally unique MAC address for the target. That can be achieved by forwarding ARP requests to tenant group members and allowing tenant group members to reply to ARP requests. As a result, packet 223 and packet 224 do not contain any location-based source and destination MAC addresses. Virtual switch 222 maintains mappings between the globally-unique MAC addresses and the location-based MAC addresses assigned to the VMs. Virtual switch 222 encapsulates a packet from VM 221 in a Provider Backbone Bridges (PBB) encapsulation. For example, packet 223 is encapsulated in packet 225. The outer destination and source MAC addresses of packet 225 are location-based MAC addresses of the target VM and VM 221, respectively. Similarly, virtual switch 222 decapsulates packet 226 and forward packet 224 to VM 221. Other encapsulation method can be used such as MPLS and GRE.

FIG. 4d illustrates an embodiment of using location-based MAC address for a data center switch fabric partitioned into multiple partitions while the partitions are separated by an IP network. The traffic from one partition to another partition needs to be tunneled through the IP network. There can be various embodiments of tunneling the traffic. One embodiment is to forward packets to another partition to a special gateway and let the special gateway encapsulate the packets using MPLS. Another embodiment is to have a virtual switch encapsulate the packets from its connected VMs to another partition using MPLS. The embodiment in FIG. 4d uses virtual switch to encapsulate the packets using MPLS and uses MAC address embodiment of FIG. 2d. Virtual switch 232 uses the tier 2 location identifier of the destination MAC address to identify that the packet is for another partition. Virtual switch 232 encapsulates packet 233 into packet 235. The outer destination MAC address of packet 235 points to a switch that has a connection to an IP network that supports MPLS.

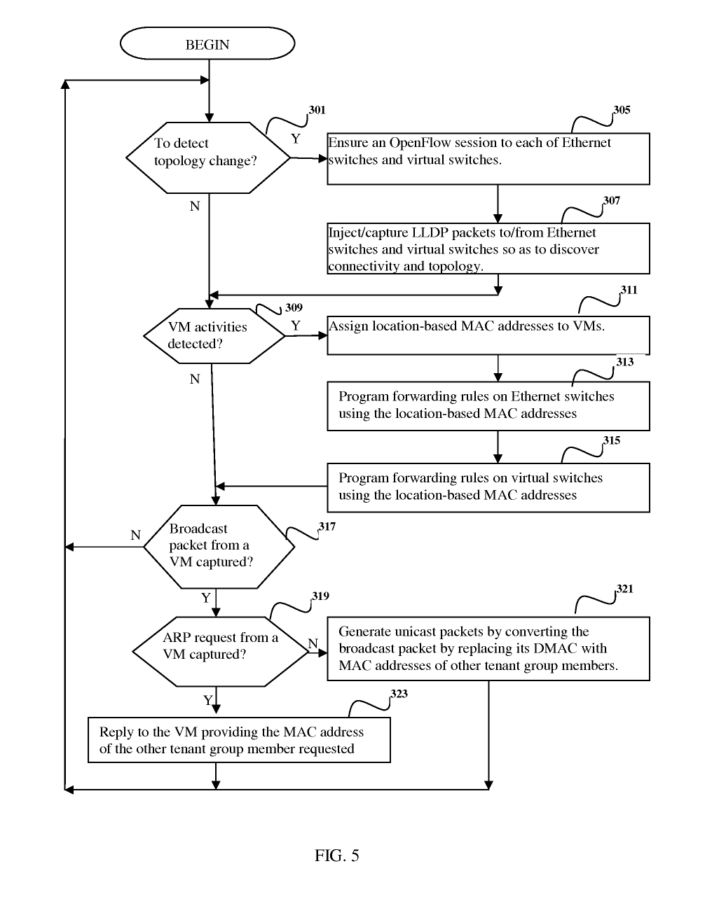

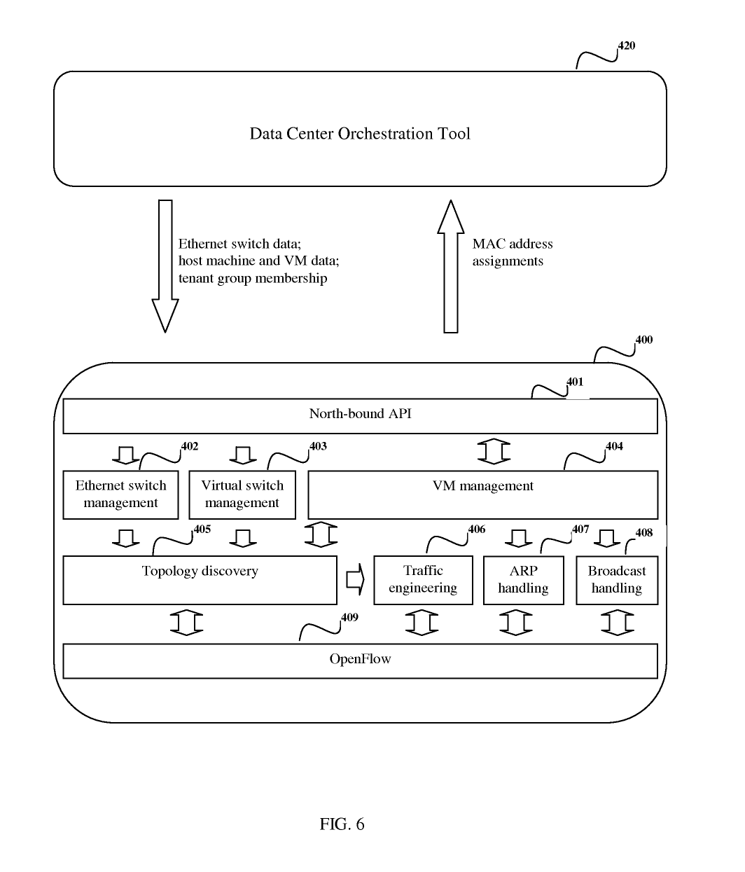

FIG. 5 illustrates an embodiment of the method of the present invention on a controller. In step 301, the controller decides whether to detect topology now or later. The controller should obtain a list of Ethernet switches and virtual switches and their associated information from a data center orchestration tool. The decision can be based on whether there is any difference between the current list and a list cached in the controller. An addition or a removal often implies topology change. The decision can also be based on a timer. The decision can also be based on loss of an OpenFlow session. The decision can also be based on a link status change event.

In step 305, the controller ensures that there is an OpenFlow session to each of the Ethernet switches and virtual switches in the switch fabric. Here we assume that the data center orchestration tool has configured the Ethernet switches and virtual switches to be able to accept OpenFlow sessions. If there is not an existing session to an Ethernet switch or a virtual switch, the controller establishes one. The controller may have network connectivity to the Ethernet switches via their management Ethernet interfaces different from the switch ports.

In step 307, the controller discovers the network topology via Link Layer Discovery Protocol (LLDP). The controller injects LLDP packets into each of the Ethernet switches and virtual switches via the corresponding OpenFlow session. The LLDP packets are to be sent out on each port of the switch entity. Some or all of those LLDP packets are to be received by the peering switch entities. The controller captures those received LLDP packets via OpenFlow sessions and thereby deducing the network topology. The connectivity between VMs and their virtual switches are obtained from the data center orchestration tool.

In step 309, the controller detects whether there is any addition, removal, or migration of VMs. The controller may obtain related information from the data center orchestration tool.

In step 311, the controller assigns a location-based MAC address to an added or a migrated VM. The location is determined with respect to the network topology. When the embodiment of using MAC address requires that the VM be using the location-based MAC address directly, the controller informs the data center orchestration tool about the assignment, and the data center orchestration tool is to configure the location-based MAC address on the VM.

In step 313, the controller programs forwarding rules onto the Ethernet switches using the location-based MAC addresses. Various implementations of the forwarding rules are illustrated in FIGS. 3a-3h.

In step 315, the controller programs forwarding rules onto the virtual switches using the location-based MAC addresses. Various implementations of the forwarding rules are illustrated in FIGS. 3a-3h and FIGS. 4a-4d.

In step 317, the controller checks whether there is any broadcast packet from a VM captured and received via an OpenFlow session. The check can only be valid if the controller has programmed the virtual switches to forward broadcast packets from VMs to the controller via the OpenFlow sessions in step 315. Otherwise, it is expected that a special gateway or the virtual switches are to handle broadcast packets and ARP requests captured on the virtual switches.

In step 319, the controller differentiates an ARP request from other broadcast packets. In step 321, the controller generates unicast packets by converting a broadcast packet by replacing the destination MAC address of the broadcast packet with MAC addresses of other tenant group members. In step 323, the controller provides the MAC address of the tenant group member requested by the VM that has sent the ARP request.

FIG. 6 illustrates an embodiment of a controller in terms of functional modules. The controller 400 comprises a number of functional modules. The North-bound API (Application Programming Interface) module 401 provides an interface between the controller 400 and the data center orchestration tool 420. The information received from the data center orchestration tool 420 includes a list of the Ethernet switches and virtual switches and their associated data and information about VMs on the host machines and tenant group membership. The controller 400 may provide the location-based MAC address assignments to the data center orchestration tool 420.

The information about Ethernet switches is passed from the North-bound API module 401 to the Ethernet switch management module 402. The information about the virtual switches is passed to the virtual switch management module 403. The information about VMs is passed to VM management module 404. The Ethernet switch management module 402 and the virtual switch management module 403 maintain the OpenFlow sessions, as in step 305 of FIG. 5. The topology discovery module 405 injects LLDP packets to and captures LLDP packets from the Ethernet switches and virtual switches to discover network topology, as in step 307 of FIG. 5. Using the network topology, the VM management module 404 assigns location-based MAC addresses to VMs, as in step 311 of FIG. 5. The traffic engineering module 406 programs forwarding rules using location-based MAC addresses onto the switch fabric, as in steps 313 and 315 of FIG. 5. The ARP handling module 407 handles ARP requests, as in step 323 of FIG. 5. The broadcast handling module 408 handles broadcast packets, as in step 321 of FIG. 5. The OpenFlow module 409 provides South-bound interface to the Ethernet switches and virtual switches.

The present invention is also applicable to a data center network that comprises non-virtualized physical machines. In that case, the forwarding rules that would be applied to virtual switches are applied to the edge switches.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A computer-implemented method for enabling communications among a plurality of virtual machines via a switch fabric, the method comprising:
in said switch fabric comprising a plurality of Ethernet switches and a plurality of virtual switches, wherein said plurality of virtual switches and said plurality of virtual machines are running on a plurality of host machines, wherein each of said plurality of host machines hosts one of said plurality of virtual switches and a subset of said plurality of virtual machines, wherein said one of said plurality of virtual switches provides connectivity among said subset of said plurality of virtual machines and at least one of said plurality of Ethernet switches, and wherein each of said plurality of virtual machines belongs to one of at least one tenant group, assigning a MAC (Media Access Control) address to a virtual machine, of said plurality of virtual machines, wherein a set of bits of said MAC address identifies a location of said virtual machine in said switch fabric; and
programming said switch fabric to forward a unicast packet destined to said MAC address by using at least one bit of said set of bits of said MAC address.

2. The method as in claim 1, wherein said set of bits of said MAC address consists of less than forty-eight bits.

3. The method as in claim 1, wherein said set of bits of said MAC address comprises a first subset of bits that identifies a virtual network interface, of a virtual switch, of said plurality of virtual switches, wherein said virtual switch and said virtual machine run on a host machine, of said plurality of host machines, wherein said virtual network interface connects said virtual switch to said virtual machine.

4. The method as in claim 3, wherein said set of bits of said MAC address further comprises a second subset of bits that identifies an edge port, of an Ethernet switch, of said plurality of Ethernet switches, wherein said edge port connects said Ethernet switch to said host machine.

5. The method as in claim 4, wherein said set of bits of said MAC address further comprises a third subset of bits that identifies said Ethernet switch.

6. The method as in claim 5, wherein said set of bits of said MAC address further comprises a fourth subset of bits that identifies the tenant group of said virtual machine.

7. The method as in claim 6, wherein said set of bits of said MAC address further comprises a fifth subset of bits that identifies a higher-tier Ethernet switch, of said plurality of Ethernet switches, wherein said higher-tier Ethernet switch is connected to said Ethernet switch.

8. The method as in claim 6, wherein said set of bits of said MAC address further comprises a fifth subset of bits that identifies a partition of said switch fabric.

9. The method as in claim 4, wherein said edge port is a logical edge port and is mapped to a link aggregation (LAG).

10. The method as in claim 9, wherein said Ethernet switch is a logical Ethernet switch and is mapped to an aggregation of Ethernet switches, of said plurality of Ethernet switches.

11. The method as in claim 1, further comprising programming said switch fabric to discard a unicast packet from said virtual machine to another of said plurality of virtual machines that does not belong to the tenant group of said virtual machine.

12. The method as in claim 1, further comprising programming said switch fabric to discard a packet from said virtual machine when a source MAC address of said packet does not comprise said set of bits of said MAC address.

13. The method as in claim 1, further comprising programming said switch fabric to forward a broadcast packet from said virtual machine to a specified server.

14. The method as in claim 13, wherein said specified server converts said broadcast packet into one or more unicast packets destined to all other members of the tenant group of said virtual machine.

15. The method as in claim 13, wherein said specified server generates an Address Resolution Protocol (ARP) response to said virtual machine when said broadcast packet is an ARP request.

16. The method as in claim 1, further comprising programming said switch fabric to forward a packet from said virtual machine destined to another of said plurality of virtual machines via a tunnel through an IP network, wherein said switch fabric is split into at least two partitions by said IP network, wherein said virtual machine is located in one of said at least two partitions, and wherein said another of said plurality of virtual machines is located in another of said at least two partitions.

17. The method as in claim 3, wherein said virtual switch is programmed to forward said unicast packet destined to said MAC address to said virtual machine without any packet modification when said virtual machine sends packets using said MAC address as a source MAC address of said packets.

18. The method as in claim 3, wherein said virtual switch is programmed to forward said unicast packet destined to said MAC address to said virtual machine after replacing said MAC address with a non-location-based MAC address of said virtual machine when said virtual machine sends packets using said non-location-based MAC address of said virtual machine as a source MAC address of said packets.

19. The method as in claim 3, wherein said virtual switch is programmed to forward said unicast packet destined to said MAC address to said virtual machine after removing an outer encapsulation that uses said MAC address as a destination MAC address of said outer encapsulation when said unicast packet comprises an encapsulated Ethernet frame.

20. The method as in claim 3, further comprising programming said virtual switch to convert a broadcast packet from said virtual machine into one or more unicast packets destined to all other members of the tenant group of said virtual machine.

21. The method as in claim 3, further comprising programming said virtual switch to generate an ARP response to an ARP request from said virtual machine.

22. The method as in claim 3, wherein said virtual network interface may be mapped to one or more physical network interfaces on said host machine.

23. A switch fabric that enables communications among a plurality of virtual machines, the switch fabric comprising:
a plurality of Ethernet switches;
a plurality of virtual switches, wherein said plurality of virtual switches and said plurality of virtual machines are running on a plurality of host machines, wherein each of said plurality of host machines hosts one of said plurality of virtual switches and a subset of said plurality of virtual machines, wherein said one of said plurality of virtual switches provides connectivity among said subset of said plurality of virtual machines and at least one of said plurality of Ethernet switches, and wherein each of said plurality of virtual machines belongs to one of at least one tenant group; and
a controller, the controller executing processing steps comprising:
assigning a MAC (Media Access Control) address to a virtual machine, of said plurality of virtual machines, wherein a set of bits of said MAC address identifies a location of said virtual machine in said switch fabric; and
programming said switch fabric to forward a unicast packet destined to said MAC address by using at least one bit of said set of bits of said MAC address.
